(19) United States
(12) Patent Application Publication
(10) Pub. No.: US 2014/0279340 A1
(43) Pub. Date: Sep. 18, 2014

(54) MECHANISM FOR ELIMINATING NEGATIVE SELECTION FROM ASYMMETRIC INFORMATION LATENCY

(71) Applicant: Philip Michael Iannaccone, New York, NY (US)

(72) Inventor: Philip Michael Iannaccone, New York, NY (US)

(21) Appl. No.: 13/802,846

(22) Filed: Mar. 14, 2013

(51) Int. Cl. G06Q 40/04

(52) U.S. Cl. CPC G06Q 40/04
USPC 705/37

(57) ABSTRACT

The present invention provides a mechanism to control exposure to latency induced negative trade selection in an anonymous fashion without the need for classification, characterization, or exclusion of potential trading counterparties.

### TECHNICAL FIELD

The present invention relates to the computerized trading of financial instruments and, more particularly, to a method and system for pairing orders together for execution.

### BACKGROUND OF THE INVENTION

While working a buy or sell interest, one is exposed to ongoing events and news flows which may make the intended purchase or sale less desirable. When select market participants have faster access to new relevant information or an improved ability to respond, they will attempt to transact a trade with slower individuals before they have become aware of the new input or before they have had time to react.

The purpose of this invention is to match a buyer with a seller at a point when both parties are assured that the other is not entering into the deal in response to material public information which only the more sophisticated participant has had time to consume because of technological speed advantages.

### SUMMARY OF THE INVENTION

A matching engine that compares the elapsed resting time of all matched orders in an order book and executes trades once the measured time of both orders have reached or exceeded the other sides requested minimum time constraint.

### DETAILED DESCRIPTION OF THE INVENTION

The present invention provides an improvement to the automated trade matching which is performed by the securities industry today by providing a framework that protects individuals from high speed arbitrage. This is accomplished with the introduction of a new constraint, minimum counterparty exposure time, to the identification process of orders eligible to trade. This order parameter would instruct the matching engine to only pair the order against other orders which have been resting in the order book for the specified amount of time, given by the minimum counterparty exposure time.

Minimum counterparty exposure time could most readily be introduced with a hidden order book, where buyers and sellers keep their interest private but agree to be matched at established reference prices such as the mid-point between the prevailing bid and ask price on an official exchange. Consider the following two orders as an example.

Order A, a buy order entered at 10:13:08 with a minimum counterparty exposure time of 30-seconds.

Order B, a sell order entered at 10:21:54 with a minimum counterparty exposure time of 180-seconds.

A trade would occur at 10:22:24. Order A rested for 556-seconds, which exceeds the specified 180-seconds given by Order B, and Order B rested for the required 30-seconds given by Order A.

1. A system for reading and recording an order parameter that specifies the acceptable minimum exposure time for counterparties.

2. A matching engine that only processes transactions between orders that have satisfied each other's minimum counterparty exposure time as described in claim 1.
